(19) United States
(12) Patent Application Publication
(10) Pub. No.: US 2014/0060574 A1
(43) Pub. Date: Mar. 6, 2014

(54) IN-SITU TCO CHAMBER CLEAN

(71) Applicants: Carrie Wyse, Longmont, CO (US); Glenn Mitchell, Longmont, CO (US); Robert Torres, JR., Parker, CO (US); Ramkumar Subramanian, Fremont (IN); Matt Shinriki, Longmont (JP)

(72) Inventors: Carrie Wyse, Longmont, CO (US); Glenn Mitchell, Longmont, CO (US); Robert Torres, JR., Parker, CO (US); Ramkumar Subramanian, Fremont (IN); Matt Shinriki, Longmont (JP)

(73) Assignee: MATHESON TRI-GAS, Basking Ridge, NJ (US)

(21) Appl. No.: 14/016,430

(22) Filed: Sep. 3, 2013

Related U.S. Application Data
(60) Provisional application No. 61/743,481, filed on Sep. 4, 2012.

(51) Int. Cl. B08B 7/00

(52) U.S. Cl. CPC B08B 7/00
USPC 134/3; 134/2

(57) ABSTRACT

The present invention discloses new chamber clean chemistries for low temperature, gas phase, in-situ removal of fluorine doped tin oxide (FTO) films. These new in-situ cleaning chemistries will enable solar glass and low-emissivity glass manufacturers to improve the quality of FTO films produced, as well as reduce costs associated manual cleaning of FTO deposition systems. The end result is increased production throughput and better quality FTO films. This is achieved by using gas phase, in-situ cleaning molecules, such as, but not limited to, HI, CH₃I, and HBr, in the FTO deposition chamber to remove unwanted buildup of FTO from chamber walls and components. Significant revenue can be derived from this customer benefit through molecule and technology solution sales related to in-situ FTO TCO chamber cleaning.

### CROSS REFERENCE TO OTHER APPLICATIONS

This application claims benefit of provisional U.S. Application No. 61/743,481, filed Sep. 4, 2012 the disclosure of which is fully incorporated herein by reference for all purposes.

### BACKGROUND OF THE INVENTION

Tin oxide based transparent conducting oxides provide high electronic conductivity, high optical transparency in the visible spectrum, as well as good thermal stability for thin film solar cell applications. Fluorine doped tin oxide (SnO₂:F or FTO) in particular, is a very chemically and physically robust transparent conducting oxide (TCO). FTO also offers sufficient electronic and optical properties for transparent front-electrodes on glass substrates used in thin film solar cells, such as amorphous and CdTe/CdS cells. Consequently, FTO is a widely used TCO in thin film solar cells. High performance CdTe solar cells and modules are routinely manufactured on FTO coated substrates, using MOCVD processing. Other FTO deposition techniques include a variety of techniques such as plasma chemical vapor deposition (PCVD), spray pyrolysis deposition (SPD), as well as rf or dc magnetron sputtering. The current global market estimate for sales of FTO TCO materials is greater than $100 million USD and continues to grow yearly.

Current FTO cleaning technology to remove unwanted FTO residue from the deposition chamber and process equipment is very limited and costly. The robust nature of FTO, which makes it a desirable TCO, is also what makes it difficult to remove. Existing cleaning technology for FTO deposition equipment requires periodic shut down of the process, and is limited to the manual cleaning of deposition components, with very hazardous liquid chemicals. The cleaning process is time consuming and costly, and if the chamber is not sufficiently cleaned or cleaned frequently enough, temperature control of the deposition process can be lost, as well as deleterious effects on other process parameters that directly affect FTO film quality. The ultimate drawback to manual chamber cleaning is the decrease in throughput of the production process. The only alternative to manual cleaning has been the periodic replacement of the contaminated components with new equipment, which is also costly. US Patent Application 2011/0088718 and titled “Chamber Cleaning Methods Using Fluorine Containing Cleaning Compounds,” which is incorporated herein by reference for all purposes, discloses cleaning methods that reduce the time, labor, danger, and hazardous waste stream needed to clean process chambers and other equipment involved in the fabrication of electronics components.

It would be highly beneficial for FTO processes to have a gas phase cleaning process that can be delivered to the process chamber using a standard gas delivery system, that cleans the FTO contaminated chamber, in-situ, and the cleaning byproducts are removed from the chamber in the gas phase via the process exhaust.

### BRIEF SUMMARY OF THE INVENTION

Methods of cleaning process chambers used in the deposition of metal oxide materials and metals with cleaning gas chemistries, that may be non-chlorine containing and non-fluorine containing for those processes where these halogens are detrimental or are ineffective, are described. Specifically, the present invention discloses the use of gas phase chemistries that are halogenated, mixed halogenated, and/or oxy-halogenated and have reducing components to them, or are in reductive matrix, or create reactive species as a result of decomposition, to allow the in-situ cleaning of process chambers used in the deposition of metal oxide materials, metal oxide complexes, and metals. The gas phase chemistries may be selected to reduce the rate of contaminant buildup on the fabrication equipment, and/or make the contaminants more amenable to in-situ cleaning processes that do not require equipment disassembly. This is achieved by using gas phase, in-situ cleaning molecules, such as, but not limited to, HI, CH₃I, and HBr. In addition to HI, CH₃I, and HBr, other compounds may include, but are not limited to: (i) HI, HBr, HCL, HF, CH₃I, CF₃I, I₂, I₂ in H₂, H₂; (ii) HI, HBr, HCL, HF, CH₃I, CF₃I, I₂, I₂ all in reducing atmospheres (such as, but not limited to H₂, NH₃, etc.); (iii) HI, HBr, HCL, HF, CH₃I, CF₃I, I₂, I₂ all in oxidizing atmospheres (such as, but not limited to O₂, H₂O, O₃, etc.); (iv) HFE, HFE with Iodocompounds, HFE with Iodocompounds and O₂, HFE with H₂, HFE with H₂ and O₂. Azomethane, azo-tertiary butane, benzene azomethane similar “azo” compounds, especially those that decompose readily with heat. Perfluorotertiary amines. Tertiary amines, and other amines, exp. those that decompose readily with heat. With particular emphasis placed on the following chemistries: Hydrogen Iodide (HI), Methyl Iodide (CH₃I) with H₂, Hydrogen Bromide (HBr), HFE-7100 (isomeric mixture of (CF₃)₂CFCF₂OCH₃ and CF₃CF₂CF₂CF₂OCH₃)) with H₂.

The present invention focuses on the formation of hydrides, metal hydrides, organometallics, halogenated compounds, oxy-halogenated compounds, and/or iodides as the volatile reaction products/byproducts, which are more easily removed from the chamber.

This invention also provides the added benefit of not necessarily requiring a plasma source for the chamber clean to occur, like some other existing technology. Rather some embodiments of this invention utilize molecules or mixtures of molecules which, when treated with heat (thermal processing), light, or other activation processes, form reducing, oxidizing, or otherwise reactive species that react with the deposit forming volatile chamber clean products.

The chamber cleaning mixtures of the present invention can be comprised of single or multiple molecules, including inert gases, reducing agents, oxidizing agents, modulating agents other chamber clean agents, or other molecules deemed beneficial to the chamber cleaning process.

Typical temperature ranges for in-situ TCO chamber cleaning of the present invention can be lower than typical process temperatures, examples of which is seen in the Examples and Figures described below. The concentrations of the chamber clean mixtures of the present invention may vary, ranging from below 0.5% to 100% and may be delivered by way of bubblers, sublimators, gas delivery systems.

The in-situ chamber cleaning disclosed by the present invention can be performed in one step or many steps, using a single chemistry or combination of many chemistries as mentioned above.

For a particular class of cleaning chemistries called hydrofluorinated ethers, or HFEs, the present invention exists a single step process in which TCOs can be doped with fluorine and the chamber cleaned simultaneously.

In particular, process equipment that is required for the manufacture of transparent conducting oxides (TCOs) is targeted, specifically fluorine doped tin oxide (FTO). In addition, other TCO's, other doped TCOs (ITO, ZnO, etc.) and binary metal TCOs are applicable. Applications of TCOs in the industry are in solar cells and OLEDs, to name a few. However, another aspect of this invention is for cleaning of the process equipment for deposition of other TCO or metal oxide materials based on Group IIA, IIIA, IVA elements.

Another aspect of this invention is for cleaning the process equipment for deposition of metal or elemental materials, based on Group IIB, IIIA, IVA elements.

Embodiments of the invention may also include in-situ cleaning methods to clean a processing chamber applicable for some metallic deposition processes, such as the removal of tin metal (Sn) in the extreme ultraviolet (EUV) lithography application, particularly on the focusing mirrors.

Embodiments of the invention may also include in-situ cleaning methods to clean a processing chamber applicable some Thermal ALD and Plasma Enhanced ALD systems, such as the removal of Al, AlN, AlO₂, Bi, Bi₂O₃, BiFeO₃, Co, Ni, W, CoFe₂O₄, Ge, GeₓSb_{y}Te_{z}, Hf, HfO₂, HfSiOₓ, La, La₂₋ₓYₓO₃, LaAlO₃, La₂O₃, Sb, Sr₂O₃, Ba₂O₃, Mn, Mn₄N, Mo, MoO₃, Nb, NiO, Ru, RuO₂, SrTiO₃, Ta, TaN, Te, Si, Ti, TiN, TiON, TiO₂, V, VN, W, WN, (SiN). Alternatively, these could be generally categorized as transition metal, Group IIIA, IVA, VA, VIA element based ALD and PEALD materials, and Lanthanide elements as well.

The process steps typically involve the introduction of the cleaning gas chemistries into the process chamber, and may further involve the activation of those gases by thermal, in-situ plasma, remote plasma, and/or chemical reaction mechanisms.

The ability to conduct on-line and in-situ chamber cleaning of the deposition processes of these materials would be highly beneficial to a variety of thin film deposition processes (e.g. CVD, etc). In-situ chamber cleaning would allow the deposition chamber and all its components to remain installed and on-line, while a chamber clean gas or gas mixture is delivered in the gas phase to the process equipment that needs to be cleaned. This would typically require no dismantling or physical removal of the chamber, thereby reducing down time, labor, and remove the risk associated with physically handling the equipment outside. Resulting in enhanced commercial processes based on improved quality of product due to better process control, and increased productivity and tool throughput due to reduced down time on process tools. Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the disclosed embodiments may be realized by reference to the remaining portions of the specification and the drawings.

FIG. 1 provides a summary plot of the results from FTO powder removal studies at different temperatures using 4 different chamber clean chemistries, in the form of temperature profile plots for FTO Powder samples. This plot shows the rate of mass change of FTO powder samples, as a function of temperature, for a 15 minute run time for each chamber clean mixture.

FIG. 2 provides a summary plot of the results from FTO film removal studies at different temperatures using 4 different chamber clean chemistries, in the form of temperature profile plots for FTO Film samples. This plot shows FTO film removal results displayed as percent mass change as a function of temperature, for the FTO film samples on glass.

FIG. 3 provides a summary plot of the results from SnO₂ film removal studies at different temperatures using 4 different chamber clean chemistries, in the form of temperature profile plots for SnO₂ Film samples. This plot shows the SnO₂ film removal results displayed as percent mass change as a function of temperature, for the SnO₂ film samples on Si wafer.

### DETAILED DESCRIPTION OF THE INVENTION

The present invention discloses the use of gas phase chemistries (alternatively referred to herein as a clean gas mixture) that are halogenated, mixed halogenated, and/or oxy-halogenated and have reducing components, or are in reductive matrix, and/or create reactive species upon thermal decomposition, to allow the in-situ cleaning of process chambers used in the deposition metal oxide materials and metals such as, but not limited to the Group IIB, IIIA, IVA elements. One aspect of this invention is that the chamber clean chemistries may be effective with only thermal activation. In particular, process equipment that is required for the manufacture of transparent conducting oxides (TCOs) is targeted. TCOs, specifically fluorine doped tin oxide (FTO), have become increasingly important for the manufacture of solar glass in the photovoltaics (PV) industry and low emissivity glass for energy efficient windows. FTO is notably difficult to remove from the process chamber walls due to its particularly robust chemical and thermal properties. In addition, ITO and ZnO TCOs are important components in the manufacture of PV cells and organic light emitting diodes (OLEDs).

Tin, zinc, and indium based metal oxide thin films are commonly used in the manufacture TCOs. Thus chamber clean chemistries for tin, zinc, and indium based materials are a major focus of this invention. It should be noted that new TCOs compositions are being developed, in order to achieve an optimal balance between low resistivity and maintaining sufficient optical transparency in the TCO layers for a given device. Thus, the chamber clean chemistries covered in this invention are expected to apply to any future compositions which may be developed and are tin, zinc, or indium based, or other oxides based on Group IIB, IIIA, or IVA elements.

There is also a need for in-situ chamber clean chemistries for some metallic deposition processes, such as the removal of tin metal (Sn) in the extreme ultraviolet (EUV) lithography application. In the EUV process, unwanted Sn material can deposit on a reflective minor which can degrade the quality of the lithographic process. To physically clean the mirror or replace the minor requires significant down time, and thus an in-situ cleaning chemistry would be very beneficial. Another aspect of this invention is chamber clean of metal contamination from processes, for example Sn metal contamination in EUV systems. This is also applicable to unwanted deposition or contamination consisting of any of the other Group IIB, IIIA, or WA elements in their ground state.

There is also a need for in-situ chamber clean chemistries for some Thermal ALD and Plasma Enhanced ALD systems, such as the removal of Al, AlN, AlO₂, Bi, Bi₂O₃, BiFeO₃, Co, Ni, W, CoFe₂O₄, Ge, GeₓSb_{y}Te_{z}, Hf, HfO₂, HfSiOₓ, La, La₂₋ₓYₓO₃, LaAlO₃, La₂O₃, Sb, Sr₂O₃, Ba₂O₃, Mn, Mn₄N, Mo, MoO₃, Nb, NiO, Ru, RuO₂, SrTiO₃, Ta, TaN, Te, Si, Ti, TiN, TiON, TiO₂, V, VN, W, WN, (SiN). Alternatively, these could be generally categorized as transition metal, Group IIIA, IVA, VA, VIA element based ALD and PEALD materials, and Lanthanide elements as well.

The ability to conduct on-line and in-situ chamber cleaning of the deposition processes of these materials would be highly beneficial to a variety of thin film deposition processes (e.g. CVD, etc). In-situ chamber cleaning would allow the deposition chamber and all its components to remain installed and on-line, while a chamber clean gas or gas mixture is delivered in the gas phase to the process equipment that needs to be cleaned. This would require no dismantling or physical removal of the chamber, reduce down time, labor, and remove the risk associated with physically handling the equipment outside. Most deposition process tools are equipped with the ability to heat the chamber, and thus chamber clean chemistries that are active at elevated temperature are particularly suited for these applications. Preferred processes which may benefit from a chamber clean using these chamber clean chemistries include spray pyrolysis, CVD, PECVD, PVD, and sputtering. While the in-situ application is the primary focus of the present invention another aspect of the invention is the ex-situ application of the chamber clean chemistries described herein. In addition, while the primary focus of the present invention is on chamber clean of metal oxide material applications, another aspect of this invention is the chamber clean of metallic materials, or Group IIB, IIIA, and IVA element based material applications.

### One-Step Chamber Clean:

Being an “on-line' process, in-situ cleaning could be integrated into the fabrication processes performed by the equipment in a variety of ways depending on the desired parameters. For example, the cleaning method could be performed between each deposition to prevent contaminants from accumulating in the process chamber from one deposition to the next. It could be run in such a way that a constant level of acceptable or desired buildup is maintained, or it could also be performed periodically after a predetermined number of depositions (e.g., about 2, 3, 4, 5, 6, 7, 8, 9, 10, 15, 20, 25, 30, depositions, etc.). Another alternative is to monitor the process chamber for buildup of contaminants and execute the cleaning method when the contaminants exceed a threshold level in the chamber.

In still additional alternatives, the chamber clean gas mixture may be compatible with the process step taking place in the process chamber (e.g., a deposition process, a doping process, an etching process, a CMP process, etc.) allowing the execution of the process step and the cleaning method at the same time thereby preventing unwanted accumulation on the walls of the chamber, provided it does not detrimentally affect the deposition on the intended substrate too negatively.

In addition to the listed materials being used by themselves, they can also be combined with each other, or with other beneficial molecules, to make a mixture that has enhanced chamber clean properties over the individual components alone. Note that these materials can also be delivered with, or pre-mixed with, an inert gas matrix (such as N₂, Ar, He, Xe, and diatomic molecules such as N₂, and mixtures of these) in addition to non-inert materials (such as H₂, O₂, H₂O, I₂, Cl₂, CF₃I, Cl₂). For such gas matrix combinations the concentrations of the material in the matrix gas may be varied (from ˜1% to ˜99%) depending on the process. This can be particularly useful for the purpose of fine tuning the chemistry to make a reducing matrix, and oxidizing matrix, wet matrix, dynamically changing matrix with reactive intermediates, etc.

The chamber clean gas mixture can also consist of a mixture that is not particularly reactive on its own towards the deposits to be cleaned, however when combined under other conditions (e.g., elevated temperature, pressure, plasma, UV light, etc.) it may become more reactive to form products or intermediate species which may be particularly more reactive with the unwanted deposits.

The cleaning gas mixture may react with the contaminants to generate reaction products of the cleaning gas mixture. The reactions may be facilitated by the thermal or plasma activation of the cleaning gas mixture. Thermal activation may include adjusting the temperature of the cleaning gas mixture in a chamber to at least a threshold temperature (e.g., in the range of about 100° C.-700° C., or up to 1500° C.) and in a pressure range of sub-atmospheric (˜10⁻⁶ Torr) to 20 psig, at which one or more components of the cleaning gas mixture react with the contaminants. Plasma activation may include exposing the cleaning gas mixture (or activatable components of the mixture) to a plasma that may be generated either remotely from the processing chamber, or within (in-situ) the processing chamber.

The method may include the step of forming the contaminants on a surface of the process equipment exposed to process gases that help form at least a part of the electronics component. The contaminants may be a coating, film layer, residue, etc., that includes tin-containing contaminants, metal-oxide contaminants, or combinations of both types of contaminants. For example, the contaminants may include tin-oxide-containing contaminants formed on exposed surfaces of the process chamber during the deposition of tin-oxide layers on a substrate surface that forms part of the electronics component (e.g., a transparent conducting oxide (TCO in a solar PV cell).

The cleaning gas mixture reacts with the contaminants to form a gas-phase reaction product. This gas-phase reaction product may be removed from the process equipment, such as, by an exhaust coupled to the process equipment. For example, the reaction product may be carried to and through the exhaust with the aid of the cleaning gas mixture and/or a carrier gas. The reaction products may also be carried to and through the exhaust with the aid of a vacuum pump and/or heat simultaneously or in sequential steps. The entire cleaning method may be done in-situ without dismantling the process equipment. The cleaning gas mixture may be introduced through the same precursor supply system used to introduce deposition, doping, etch gases, etc., to the process equipment. The reaction products may be evacuated from the processing chamber before a new substrate is provided to the processing chamber. Several tin-based, metal-oxide film depositions may occur on a series of substrates before another cleaning gas mixture is supplied to the processing chamber.

### Two-Step Chamber Clean:

Another aspect of the invention, includes the use of cycling two different chamber clean chemistries into the chamber sequentially. This would be for the case where the first chamber clean reaction products are non-volatile and do not readily leave the chamber, but a second chamber clean chemistry reacts with the first non-volatile products to form more volatile products that can be more easily removed from the chamber. In this case, the first and second steps would be repeatedly cycled, until enough of the unwanted deposit is removed from the chamber, rendering it sufficiently clean. (Similar to a reverse ALD process.)

Although the experiments described below do not include any two-step, or multistep cleaning methods, this invention includes the possibility of using a multi-step process or cycling process that would facilitate the removal of any residues remaining after certain cleaning step. Additionally, the cleaning chemistries detailed in this invention are not limited to FTO deposits, and can be applied to other tin based materials (e.g. SnO₂, ITO, Sn metal), and they are not limited to TCO related deposits, and can be applied to Group IIB, IIIA, and IVA based non-TCO metal oxide applications.

Some background experiments using liquid bromine (Br₂) with samples of different TCOs and metals have been conducted and demonstrate some reactivity towards these materials. Although Br₂ is very corrosive to the materials of composition for most gas distribution systems, these experiments reveal information about the chemistry of halogens with these materials.

### Metals Oxide Materials to be Cleaned In-situ:

Preferred materials to be removed from deposition equipment included in this invention, include, but are not limited to, tin oxides (SnO₂), fluorine doped tin oxides (aka “FTO” or “SnO₂:F”), other doped tin oxides (Sb doped tin oxides, Zr doped tin oxides), cadmium tin oxides (CdSnO), zinc oxides (ZnO), Al doped zinc oxides (AZO), and tin doped indium oxides (ITO), see Table 1 below. The invention also includes chemistries for the cleaning of binary metal TCOs such as Cd₂SnO₄, Zn₂SnO₄, and In₂Zn₂O₅. Furthermore, complex TCO compositions are also included (such as Cd₁₊ₓIn₂-2ₓSnₓO₄).

TABLE 1

| TCOs | | |
|---|---|---|
| (Conventional Basis Sets) | Doped TCOs | Binary Metal TCOs |
| SnO₂ | Sn doped In₂O₃ (ITO) | Cd₂SnO₄ |
| In₂O₃ | Al doped ZnO₂ (AZO) | Zn₂SnO₄ |
| ZnO | F doped SnO₂ (FTO) | In₂ZnO₅ |
| CdO | Sb doped SnO₂ | |
| Ga₂O₃ | Zr doped SnO₂ | |

Other specific TCO's also included, but are not limited to: CdO, CdSnO₂, CdO:In, Cd₂SnO₄, CdIn₂O₄, ZnO:F, ZnO:Ga, ZnO:B, ZnO:In, ZnSnO₃, Zn₂SnO₄, Zn₂In₂O₅, a-IZO (Amorpous In—Zn—O) and GaInO₃

### Examples for FTO:

Specifically, the CVD process for making FTO (SnO₂:F) films also produces FTO deposits on the inside walls of the deposition chamber and equipment. As these unwanted deposits become thicker, the deposition process eventually becomes out of tolerance of the process control parameters, and the deposition chamber needs to be cleaned. Conventional methods used to remove the unwanted FTO deposit requires disassembly of the chamber and physical scrubbing of the hardware with hazardous chemicals.

Preliminary experiments demonstrate that dilute HBr (1%) in nitrogen effectively and completely removes FTO film from glass at temperatures as low as 300° C. and a pressure of 800 Torr.

Additionally, hydrogen iodide (HI), at concentrations of 5% and 20% in inert balance gas, has also been found to be an effective agent for removing FTO films from glass at temperatures below 200° C.

Methyl iodide CH₃I (5%) in H₂ (5%) has also been found to be effective for removing FTO at 500° C. and possibly lower temperatures.

### Examples for SnO₂, ITO, and ZnO:

Preliminary experiments demonstrate that HBr (1%), HI (5%, 20%), iodine (I₂) in H₂ (5%), H₂ (5%), CF₃I (30%), CH₃I (5%) in H₂ (5%), and Bromine (Br₂) effectively remove SnO₂ film at relatively low temperature.

Preliminary experiments demonstrate that HBr (1%), HI (5%, 20%), iodine (I₂) in H₂ (5%), H₂ (5%), CF₃I (30%), CH₃I (5%) in H₂ (5%), Bromine (Br₂) and HFE react with ITO film at relatively low temperature.

Preliminary experiments demonstrate that HBr (1%) and CH₃I (5%) in H₂ (5%), and Bromine (Br₂) react with ZnO film at relatively low temperature.

### Tin (Sn) Metal to be Cleaned In-situ:

Sn in EUV Lithography

Another aspect of this invention is the use of in-situ gas phase chamber clean chemistry to remove unwanted tin metal (Sn) deposits from the process equipment. One specific application for this is Extreme Ultraviolet (EUV) lithography. In EUV lithography, microscopic droplets of molten tin are directed through a vacuum chamber and individually vaporized by a pulsed high power infrared laser. This creates a high temperature tin plasma point source of light that is then used for lithography. A large minor collects and directs this UV light into a complex set of optics for lithography to take place. Unwanted tin metal can deposit on this mirror which has detrimental effects on the quality of the lithography. The need to remove the Sn metal off of the minor surface or replacing the minor requires significant tool down time. An in-situ cleaning process to remove Sn metal that does not require dismantling the tool and is non-corrosive to the other tool components would be highly beneficial. Chlorine and fluorine are unwanted contaminants and known to be corrosive to EUV equipment. Therefore an EUV chamber clean chemistry must not contain Cl or F atoms.

Examples for Sn:

Preliminary experiments demonstrate that dilute HBr (1%) in nitrogen effectively and removes Sn metal film at temperatures as low as 100° C. Dilute HI (5% and 20%) has also been found to be effective at removing Sn metal.

Specific examples of possible materials for chamber clean chemistries for the above mentioned applications and technologies (included, but not limited to):

The chamber clean chemistries included in this invention focused on a reductive matrix that is also halogenated. In particular, such chamber clean chemistries may include halogenated, mixed halogenated, and oxy-halogenated species, as well as reductive species, and/or any of these species in a reductive gas matrix. The chamber clean chemistries included in this invention are focused on the formation of metal hydrides, organo-metallics, metal halides, metal oxy-halides, and/or mixed metal halides and metal oxy-halides as the volatile reaction products.

Under certain circumstances, oxygenated species (e.g., O₂) may be added to provide cleaning chemistry as well.

Organometallics include molecules with metals bonded to saturated and unsaturated hydrocarbons, including branched, cyclic, aromatic and all isomers of a given molecular formula.

Saturated and unsaturated hydrocarbons may or may not contain other active atoms, including but not limited to oxygen, nitrogen, sulfur, etc., all isomers of a molecular formula including cyclic and branched. Also including are those saturated and unstaturated hydrocarbons with one or more hydrogen atoms replaced by iodine atoms, which may or may not contain other atoms including but not limited to oxygen, nitrogen, sulfur, etc. and all isomers of a molecular formula including cyclic and branched.

One embodiment of this invention specifically includes the use of iodo-compounds (e.g. I₂, HI, CH₃I, etc.) in a reductive matrix of hydrogen (e.g., H₂) to form volatile products. The reductive matrix can be from a mixture prepared by mixing the iodo-compound with a reducing gas (eg. H₂), or it can also be a mixture that naturally forms in a container from the natural decomposition of the iodo-compound (eg. HI cylinder that also contains H₂ as a result of HI decomposition.)This invention also includes chamber clean chemistries that are non-chlorine containing and non-fluorine containing for those processes where these halogens are detrimental.

Other specific materials for chamber clean include, but are not limited to: HI, HBr, HCL, HF, CH₃I, CF₃I, I₂, I₂ in H₂, H₂; HI, HBr, HCL, HF, CH₃I, CF₃I, I₂, I₂ all in reducing atmospheres (such as, but not limited to H₂, NH₃, etc.); HI, HBr, HCL, HF, CH₃I, CF₃I, I₂, I₂ all in oxidizing atmospheres (such as, but not limited to O₂, H₂O, O_{3,} etc.); HFE, HFE with iodo-compounds, HFE with iodo-compounds and O₂, HFE with H₂, HFE with H₂ and O₂. Azomethane, azo-tertiary butane, benzene azomethane similar “azo” compounds, especially those that decompose readily with heat. Perfluorotertiary amines, tertiary amines, and other amines, especially those that decompose readily with heat. With particular emphasis placed on the following chemistries: Hydrogen Iodide (HI), Methyl Iodide (CH₃I) with H₂, Hydrogen Bromide (HBr), HFE-7100 (isomeric mixture of (CF₃)₂CFCF₂OCH₃ and CF₃CF₂CF₂CF₂OCH₃)) with H₂.

### Methods and Materials

The following methods and materials were used in the examples listed below:

### Samples Tested:

FTO residue powder collected from commercial FTO deposition chamber
approximately 0.4 g powder in 316L Stainless Steel cup
(approximately ¼ in. diameter exposure area)

FTO film on glass (commercial sample coupons)
approximately 350 nm FTO film (0.00030 g) on glass
approximately 1 cm2 sample

SnO₂ on Si wafer
approximately 1.75 um SnO₂ film (˜0.00120 g) on Si wafer
approximately 1 cm² sample

### Metrology Equipment:

Mettler Toledo Balance
0.00001 g sensitivity
To measure mass loss after chamber clean.

4 Point Resistivity Meter (Guardian SRM-232-1000)
To measure resistivity (Ω/sq) of FTO film before and after chamber clean.
Used to determine if conductive TCO film is present or not.

Visual observation
Change in appearance after chamber clean.
To detect any residue or peeling of surface.

### EXAMPLES

The invention is further illustrated by the following non-limited examples. All scientific and technical terms have the meanings as understood by one with ordinary skill in the art. The specific examples which follow illustrate the clean chemistry of the instant invention and are not to be construed as limiting the invention in sphere or scope. The methods and materials may be adapted to variation in order to produce the desired results embraced by this invention but not specifically disclosed. Further, variations of the methods for in-situ chamber cleaning in somewhat different fashion will be evident to one skilled in the art.

As used herein “substrate” may be a support substrate with or without layers formed thereon. The support substrate may be an insulator or a semiconductor of a variety of doping concentrations and profiles and may, for example, be a semiconductor substrate of the type used in the manufacture of integrated circuits, the substrate may also be the interior wall of the chamber and can be made of any material, such as, but not limited to stainless steels, aluminum, glass, Si wafers, o-rings, etc.

### Experimental Parameters

Chamber Clean Process Parameters—The examples described in this application consist of experiments conducted using a Hastelloy Parr Pressure Vessel with an internal volume of approximately 300 mL, at a pressure of approximately 650 Torr. Temperature ranged from 100-400 C, and the flow rate was approximately 1000 sccm. The run time for the temperature profile experiments was 15 minutes.

### Experimental Procedure

The experiment consisted of conducting initial metrology measurement on samples (mass, sheet resistance for films) and the samples were loaded into the reactor vessel. The reactor was heated and a pre-heating coil was used to heat the incoming gas, initially using inert gas to get to temperature. Once temperature stabilized, the inert gas flow was stopped, and the chamber clean gas flow commenced. Temperature, pressure, and gas flow was monitored, and after 15 minutes, the chamber clean gas flow was stopped, inert gas was turned on, and the heat was turned off. The reactor was then allowed to cool under inert purge, and samples removed from the reactor. Final metrology was obtained on the samples.

### Chamber Clean Chemistries Tested

In-situ Thermal Chamber Clean Chemistries tested in this study
(˜3%) (Hydrogen Iodide (HI))
(˜5%) (Methyl Iodide (CH₃I) w/H₂)
(˜1%) (Hydrogen Bromide (HBr))
(˜30%) (HFE-7100 (isomeric mixture of (CF₃)₂CFCF₂OCH₃ and CF₃CF₂CF₂CF₂OCH₃)) with H₂)

Temperature Profile Studies of the aforementioned Chamber Clean Chemistries run for 15 minutes at 100, 200, 300, 400° C. All temperatures are understood to be in Centigrade (° C.) when not specified.

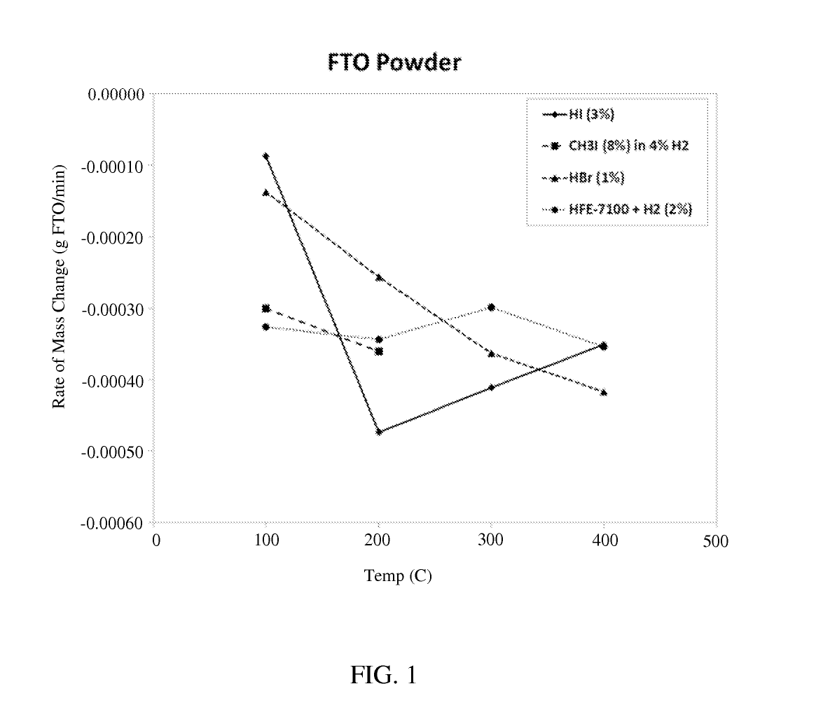

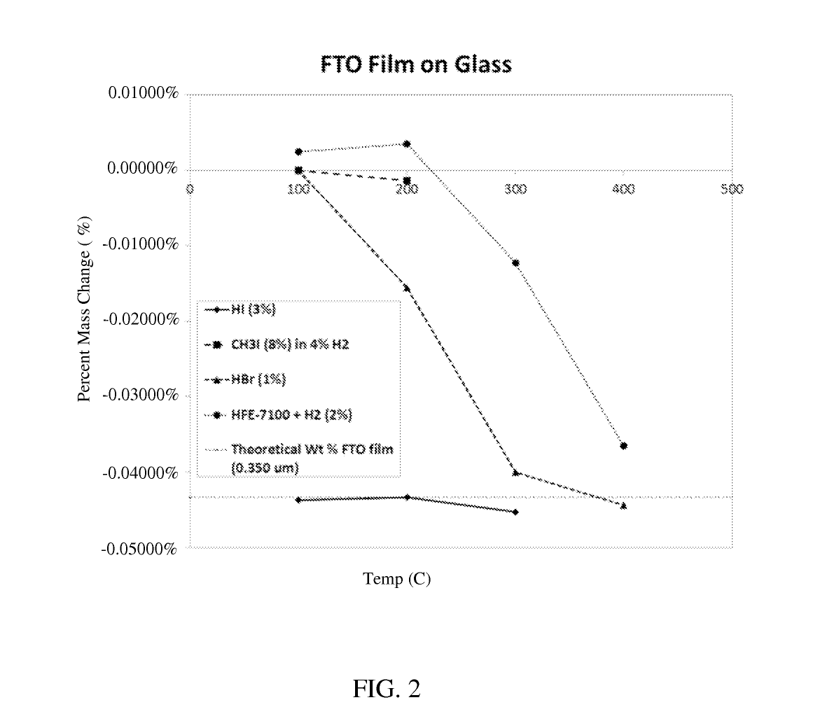

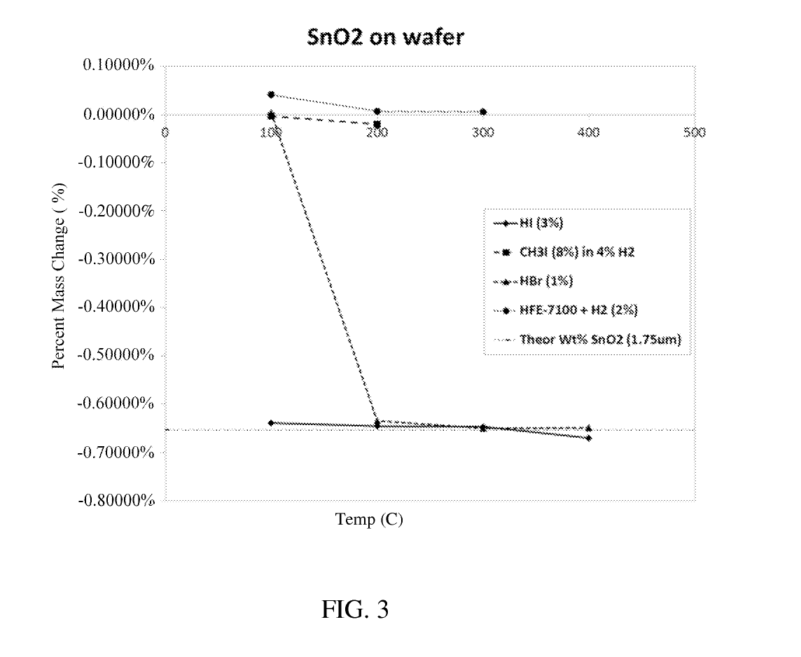

Different gas phase chemistries, hydrofluroinated ether (HFE) at ˜30%, HI at 3%, HBr at 1%, and CH₃I at ˜5%, were tested for in-situ chamber cleaning capability for removing FTO deposits. Each cleaning mixture was delivered in the gas phase to a chamber containing two different commercially available FTO film samples on glass. Temperature profile studies were conducted for each of these chemistries by flowing the gas mixture into the heated vessel containing the FTO samples for 30 minutes at temperatures of 100°, 200°, 300°, and 400° C. Gravimetric results are presented as a rate of change in mass for FTO powder samples (FIG. 1) and as percent mass loss for the FTO and SnO₂ film samples (FIGS. 2 and 3), as a function of temperature after exposure to each of the four gas mixtures. This invention is not limited to these molecules, and also includes these molecules at various concentrations, (e.g., ranging from fractions of a percent, up to pure 100%), can include ternary, quaternary, etc., mixtures, and does not exclude mixtures of the above chemistries together to make one cleaning and/or etching chemistry. Each mixture was delivered in the gas phase to a chamber containing two different FTO film samples on glass at atmospheric pressure. The two different samples tested in each experimental test were FTO samples from two different commercial suppliers. Both samples were exposed to the gas mixture for a specified time (up to a maximum of 15 minutes) at temperatures ranging from 100-400° C. at 100° C. increments. Results were obtained by gravimetric analysis of the FTO samples, before and after exposure to the gas mixtures, as well as changes in the 4-point resistivity measurements of each FTO film, before and after exposure.

The data for these chamber clean chemistries were obtained using relatively dilute mixtures in inert gas (˜1%-30%), in addition to the presence of ˜1-5% H₂ gas where mentioned.

In addition to the chemistries detailed above (HI, CH₃I, HBr, and HFE-7100) this invention also includes, but is not limited to, chamber clean chemistries that are by themselves, or as mixtures, have reducing properties (such as H₂, NH₃) oxidizing properties (such as O₂, H₂O, O₃) as well both reducing/oxidizing properties under certain parameters (such as hydrofluorinated ethers (HFE's)).

The concentrations of the chamber clean mixtures may vary, ranging from 0.5% to 100%. The chamber cleaning mixtures can be comprised of single or multiple molecules, including inert gases, reducing agents, oxidizing agents, other chamber clean agents, or other molecules deemed beneficial to the chamber cleaning process. It should be noted that the chamber clean chemistry can also consist of molecules or mixtures of molecules which, when treated with heat, light, or other activation processes, form reducing, oxidizing, or otherwise reactive species that react with the deposit forming volatile chamber clean products. Such activation processes include thermal decomposition, forming reactive chamber cleaning species.

Another aspect of this invention is the simultaneous use of chamber clean chemistries with deposition chemistries during the thin film deposition process. For example, in the case of fluorine doped tin oxide (FTO) deposition, HFE can be used as the fluorine dopant in the deposition process (along with O₂ and tetramethyl tin precursors). In addition, as demonstrated in the examples below, FTO powder can be effectively cleaned away using HFE as well. The invention is the use of Hydrofluorinated Ethers (HFEs) as a etchant material to remove/etch deposited material from the process chamber of a variety of semiconductor tools, specifically in photovoltaics, flat panels, and flexible organic substrate processes such as organic transistors or OLEDs. Preferred materials to be removed from chambers include the metal oxides and doped metal oxides (e.g.: SnO₂, SnO₂:F, ITO, ZnO, ZnO:Al, Cd₂SnO₄, In₂O₃, In₂O₃:Sn, In₂O₃:Al, CdO, and Ga₂O₃). Preferred processes which may benefit from a chamber clean using HFE include spray pyrolysis, CVD, PECVD, PVD, and sputtering.

HFE's are relatively high vapor pressure liquids that are non-hazardous, and have low global warming potential and low atmospheric lifetimes making them environmentally advantagous. HFEs create reactive fluorine species capable of etch chemistries, via thermal decomposition, plasma, or other energetic scenarios.

For example, fluorine doped tin oxide (SnO₂:F) films can be prepared by chemical vapor deposition to make the transparent conducting oxide (TCO) layer in CdTe solar cells. During this process the CVD chamber walls and internal components become coated with SnO₂:F material that can accumulate and have detrimental effects on the temperature control of deposition process. Periodic cleaning of the chamber is required to maintain a stable and reproducible deposition process. This currently must be done by physically dismantling the chamber, removing it from the tool, and mechanically scrubbing it with a combination of hazardous chemicals. This is a significant interruption in the operation of the tool, requires significant down time, carries risks of damaging chamber components, and requires extra start up procedures such as leak testing, before the operation can be resumed. It also requires the use of hazardous liquid chemicals in a manual cleaning/scrubbing process in which personnel must wear significant personal protective equipment to minimize exposure risk, and a liquid hazardous waste stream is generated.

HFE molecules are a safer, on-line alternative to clean the chamber in which the chamber and all its components can remain installed, on-line, and the HFE is delivered in the gas phase via a liquid bubbler apparatus to the chamber. This would require no dismantling or physical removal of the chamber, reduce down time, labor, and the risk associated with physically handling the equipment. Being an “on-line' process, HFE etching could be integrated into the process in a variety of ways depending on desired parameters. For example, an HFE etch could be run after each deposition in order to prevent an accumulation from building up and maintain a constant level of buildup, or periodically after a certain number of deposition runs. HFE could also be combined with other molecules such as O₂, H₂, H2O, HCl, Cl₂, HBr, HF, CF₃I etc., to fine tune or optimize the etch chemistry (e.g. reductive vs. oxidative) to the specific process/material. Furthermore, HFE could also be used in-situ during the deposition process to prevent the accumulation on the walls provided it does not detrimentally affect the deposition on the intended substrate too negatively.

### Examples of Possible Materials (Included but Not Limited to):

### General Examples:

RfOR (where R groups are alkyl chains, and Rf groups are fluorinated alkyl groups) and RfORf (where Rf groups are fluorinated alkyl groups).

### Specific Examples:

HFE-7100 (C₄F₉OCH₃), mix:(CF₃)₂CFCF₂OCF₃ and CF₃CF₂CF₂CF₂OCH₃, HFE-7200 (C₄F₉OC₂H₅), CH₃OCF₃, CF₂HOCF₃, CF₃CFHOCF₃, CF₃CH₂OCF₃, CF₃CH₂OCHF₂, CF₃CF₂OCH₃, C₄F₉OCH₃, C₄F₉OC₂H₅, C₃F₇OCH₃, RfOCH₃ (where Rf denotes fluorinated segments containing more than 4 carbon groups), RfOC₂H₅ (where Rf denotes fluorinated segments containing more than 4 carbon group.

Thus, a simultaneous process in which deposition and chamber cleaning both occur, could be developed for a given process, balancing sufficient deposition with chamber cleaning simultaneously. This would require fine tuning of any oxidative and reductive reactions in the process so that one process does not override the other.

Also, as described in the present invention, the chamber clean chemistries can be used in single or multi-step fashion, in which separate deposition and chamber cleaning steps are used, and alternated. The timing, length, and frequency of these steps would depend on the stringency of the chamber cleaning requirements as well as the deposition requirement and the throughput of the process.

FTO samples consisted of small coupons (approximately 0.5 in²) of commercially available FTO films on glass substrates (FTO film thickness equals approximately 300-500 nm, glass substrate thickness equals approximately 2 and approximately 3 mm). Each sample was carefully weighed using a calibrated 5-decimal place balance (Mettler Toledo® model XS105DU) before and after exposure to the gas mixture. The 4-point resistivity of the FTO side of each sample was also measured using a sheet resistance meter (Guardian SRM-232-1000), before and after exposure to the gas mixture.

Gravimetric results were quantified as percent mass loss after exposure to each gas mixture. Resistivity measurements were obtained to confirm the presence or absence of the film, as well as degradation of the film after exposure to the gas mixtures.

### Temperature Profile Studies

Temperature profile studies were conducted for each of the four gas mixtures by flowing the gas mixture into the heated vessel containing the FTO samples for 15 minutes at temperatures of 100°, 200°, 300°, and 400° C. After 15 minutes of contact time between the gas mixture and the FTO samples in the heated vessel, purified inert gas was purged through the vessel as it cooled to room temperature. The FTO samples were removed, rinsed with de-ionized water and isopropyl alcohol, and dried with purified N₂. The samples were then reweighed and 4-point resistivity was remeasured.

### Results and Discussion

### Temperature Profile Results

The gravimetric results from the temperature profile studies are shown in plots of the rate of change in mass as a function of temperature for the FTO powder samples (FIG. 1), and percent mass loss as a function of temperature for the film samples FIGS. 2 and 3). Note that for the FTO film samples, this measurement is only a valid reflection of the amount of FTO film removed when the glass substrate is not affected, as is believed to be the case with the gas mixtures described here.

The lowest effective temperature for chamber clean was determined based on the lowest temperature at which both the mass loss started to level off, and the sample was no longer conductive. Both of these two criteria combined were required in order to deem the FTO film removed.

Table 2 lists the minimum effective chamber clean temperatures, minimum clean times, and corresponding cleaning rates, for each gas mixture, for FTO Film samples, as determined from the temperature profiles as well as the run time studies.

TABLE 2
FTO Film Removal Results

| Gas | Min Temp to | Min Run Time to | Effective Clean |
|---|---|---|---|
| Mixture | Clean (° C.) | Clean (min) | Rate (nm FTO/min |
| (HI) | 200 | ~5 | ~100 |
| (CH₃I) in H₂ | 400 | ~15 | ~30 |
| (HBr) | 300 | ~5 | ~100 |
| (HFE) in H₂ | n/a | n/a | n/a |

Gas mixture (HI) was effective at removing the FTO film in 5 minutes, at 200° C. This correlates to a calculated etch rate of approximately 100 nm/min. Gas mixture (CH₃I) in H₂ removed the FTO film in 15 minutes at 400° C., yielding a calculated etch rate of approximately 30 nm/min. Gas mixture (HBr) removed the FTO film in 5 minutes at 300° C., which corresponds to a calculated etch rate of approximately 100 nm/min. The clean rates assume complete removal of the approximately 500 nm FTO film when the mass loss has leveled for a given time.

In the film studies, the theoretical maximum % weight loss is calculated for a given film thickness, based on film density and the proportion of the film thickness to the sample thickness. FIG. 2 demonstrates the FTO film removal results displayed as percent mass change as a function of temperature, for the FTO film samples on glass. Total removal of the FTO film occurred for HI at 100-300° C. and for HBr at 300-400° C. Significant FTO film removal occurred for HFE at 400° C. Note the theoretical weight percent of the FTO film (0.350 μm thickness) is also indicated on the plot, near the bottom x-axis.

Sheet resistivity measurements of the FTO films were also measured to confirm the presence or absence of the film, or degradation of the film after exposure to the gas mixtures.

### Summary of Results—FTO Powder

TABLE 3
FTO Powder

| Ranking | Mixture | Comments |
|---|---|---|
| 1st | (HI) | Highest removal rate at 200° C. |
| 2nd | (CH₃I) in H₂ | Moderate removal rate at 100° C. |
| 2nd | (HFE in H₂) | Moderate removal rate at 100° C. |
| 4th | (HBr) | Moderate removal rate at 300° C. |

If FTO Powder removal only is needed, the mixture of (HFE) in H₂ offers lowest temperature removal.
If highest FTO Powder removal rate is primary criteria, the mixture of (HI) offers fastest removal rate at 200° C.

### Summary of Results—FTO Film

TABLE 4
FTO film on glass

| Ranking | Mixture | Comments |
|---|---|---|
| 1st | (HI) | Total removal of FTO Film at 100° C., 200° C., |
| | | 300° C. |
| 2nd | (HBr) | Total removal of FTO Film at 300° C. and 400° C. |

If removal of FTO Film is also needed, the mixture of (HI) offers the lowest temperature removal.

### Summary of Results—SnO₂ Film

TABLE 5
SnO₂ film on wafer

| Ranking | Mixture | Comments |
|---|---|---|
| 1st | (HI) | Total removal of SnO₂ film at 100° C.-400° C. |
| 2nd | (HBr) | Total removal of SnO₂ at 200° C. |

If removal of SnO₂ Film is also needed, the mixture of (HI) offers the lowest temperature removal, see FIG. 3.

FIG. 3 demonstrates the SnO₂ film removal results displayed as percent mass change as a function of temperature, for the SnO₂ film samples on wafer. Total removal of the SnO₂ film occurred for HI at 100-300° C. and for HBr at 200-400° C. Note the theoretical weight percent of the SnO₂ film (1.75 μm thickness) also indicated near the bottom of the plot.

### Summary of Results—All Materials

FIG. 1 demonstrates the rate of mass change as a function of temperature, for FTO powder samples. If all 3 types of material (FTO powder, FTO film and SnO₂ film) need to be removed:
(HI) offers the highest removal rate at the lowest temp (200° C.); and
The mixture of (HBr) offers next highest removal rate at 300° C.

TABLE 6
All Tested Materials

| Ranking | Mixture | Comments |
|---|---|---|
| 1st | (HI) | Highest removal rate for all materials at 200° C. |
| | | Effective on powder, FTO films, and SnO₂ films. |
| 2nd | (CH₃I) in H₂ | Next highest removal for all materials at 300° C. |
| | | Effective on powder, FTO films, and SnO₂ films. |
| 3rd | (HBr) | Moderate removal of FTO powder at 200° C. |
| 4th | (HFE) in H₂ | Moderate removal of FTO powder at 100-400° C. |

### Summary

HI, HBr, and CH₃I each were found to be effective in-situ, thermally activated chamber clean chemistries for removing FTO deposit. This technical breakthrough may allow for improved quality of commercial FTO films as well as increased production throughput of FTO.

Only thermal activation is required at moderate temperatures for in-situ cleaning to be effective. Clean times for the removal of approximately 500 nm FTO films were 5 min, 5 min, and 15 min for the three different mixtures. These times correlate to calculated clean rates of approximately 100, 100, and 30 nm FTO/min, respectively.

Various in-situ chamber clean chemistries were tested for removal of fluorine doped tin oxide (FTO) films from glass sample coupons. Three gas mixtures were found to effectively remove the FTO film in the gas phase by thermal activation at moderate temperatures (200° C., 300° C., and 400° C. for the different mixtures). Clean times for the removal of approximately 500 nm FTO films were 5 min, 5 min, and 15 min respectively for gas mixtures (HI), (CH₃I) in H₂, and (HBr). This correlates to clean rates of approximately 100, 100, and 30 nm FTO/min respectively. All three gas mixtures demonstrated to be effective gas phase, in-situ chamber clean chemistries for FTO, and only moderate thermal activation was required. As FTO deposition is a high temperature process, thermal activation at these temperatures should be readily available on any FTO deposition process equipment.

Furthermore, it should be noted that the FTO sample films used in this study consisted of high quality FTO product from commercial deposition processes. These FTO films tested should be much more chemically and physically robust than the unwanted FTO residue of lower quality which builds up and contaminates a process chamber. Thus, it is reasonable to expect that lower temperatures and faster clean rates can be attained on a high throughput production process chamber. This technical breakthrough may allow for improved quality of commercial FTO deposition via tighter process control made possible by cleaner systems, in addition to increased production throughput, via reduced downtime and better quality and more frequent chamber cleans.

As used herein and in the appended claims, the singular forms “a”, “an”, and “the” include plural referents unless the context clearly dictates otherwise. Thus, for example, reference to “a process” includes a plurality of such processes and reference to “the dielectric material” includes reference to one or more dielectric materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of cleaning metal-containing contaminants from a process chamber, the method comprising: introducing a cleaning gas mixture comprising at least one halogenated, mixed halogenated, and/or oxy-halogenated to the contaminated process chamber, wherein the cleaning gas mixture reacts with at least a portion of the metal-containing contaminants to form one or more gas-phase reaction products; and evacuating the gas-phase reaction products from the process chamber.

2. The method of claim 1, further comprising introducing reducing components to the, or are in reductive matrix, to allow the in-situ cleaning of process chambers used in the deposition metal oxide materials and metals.

3. The method of claim 1, further comprising introducing thermally unstable components to the matrix, to allow the in-situ cleaning of the process chambers used in the deposition of metal oxide materials and metals.

4. The method of claim 1, wherein the metal is a Group IIB, IIIA, or IVA element.

5. The method of claim 1, wherein the metal is tin, indium, or zinc.

6. The method of claim 1, wherein a cleaning gas mixture comprises at least HI, HBr, HCl, HF, CH₃I, CF₃I, I₂, I₂ in H₂, H₂.

7. The method of claim 4, wherein HI, HBr, HCl, HF, CH₃I, CF₃I, I₂ are all in reducing or oxidizing atmospheres.

8. The method of claim 4, wherein said reducing atmospheres are H₂, NH₃.

9. The method of claim 4, wherein said oxidizing atmospheres are O₂, H₂O, O₃.

10. The method of claim 1, wherein a cleaning gas mixture comprises HFE, HFE with Iodocompounds, HFE with Iodocompounds and O₂, HFE with H₂, HFE with H₂ and O₂ or isomeric mixture of (CF₃)₂CFCF₂OCH₃ and CF₃CF₂CF₂CF₂OCH₃)) with H₂.

11. The method of claim 1, wherein a cleaning gas mixture comprises Azomethane, azo-tertiary butane, benzene azomethane.

12. The method of claim 1, wherein a cleaning gas mixture comprises similar “azo” compounds, especially those that decompose readily with heat.

13. The method of claim 1, wherein a cleaning gas mixture comprises Perfluorotertiary amines.

14. The method of claim 1, wherein a cleaning gas mixture comprises tertiary amines, and other amines, especially those that decompose readily with heat.

15. The method of claim 1, wherein HFE is selected from the group consisting of HFE-7100 (C₄F₉OCH₃), mix:(CF₃)₂CFCF₂OCF₃ and CF₃CF₂CF₂CF₂OCH₃, HFE-7200 (C₄F₉OC₂H₅), CH₃OCF₃, CF₂HOCF₃, CF₃CFHOCF₃, CF₃CH₂OCF₃, CF₃CH₂OCHF₂, CF₃CF₂OCH₃, C₄F₉OCH₃, C₄F₉OC₂H₅, C₃F₇OCH₃, RfOCH₃ (where Rf denotes fluorinated segments containing more than 4 carbon groups), RfOC₂H₅ (where Rf denotes fluorinated segments containing more than 4 carbon group.

16. The method of claim 1, wherein a cleaning gas mixture comprises RfOR (where R groups are alkyl chains, and Rf groups are fluorinated alkyl groups) and RfORf (where Rf groups are fluorinated alkyl groups).

17. An in-situ method of cleaning a process chamber used to fabricate electronics components, the method comprising: providing a cleaning gas mixture to the process chamber, wherein the cleaning gas mixture comprises at least one halogenated, mixed halogenated, and/or oxy-halogenated compound, and wherein the cleaning gas mixture removes metal-containing contaminants or metal-oxide containing contaminants from interior surfaces of the processing chamber that are exposed to the cleaning gas mixture; removing the reaction products of the cleaning gas mixture from the process chamber; and providing a substrate to the process chamber following the evacuation of the reaction products from the process chamber.

18. The method of claim 17, wherein the cleaning gas mixture comprises a carrier gas mixed with said one halogenated, mixed halogenated, and/or oxy-halogenated compound.

19. The method of claim 18, wherein the carrier gas comprises helium, argon, nitrogen, or dry air.

20. The method of claim 17, wherein the contaminants comprise a tin-oxide containing contaminant.

21. The method of claim 17, wherein a cleaning gas mixture comprises at least HI, HBr, HCl, HF, CH₃I, CF₃I, I₂, I₂ in H₂, H₂.

22. The method of claim 21, wherein HI, HBr, HCl, HF, CH₃I, CF₃I, I₂ are all in reducing or oxidizing atmospheres.

23. The method of claim 22, wherein said reducing atmospheres are H₂, NH₃.

24. The method of claim 22, wherein said oxidizing atmospheres are O₂, H₂O, O₃.

25. The method of claim 17, wherein a cleaning gas mixture comprises HFE, HFE with Iodocompounds, HFE with Iodocompounds and O₂, HFE with H₂, HFE with H₂ and O₂ or isomeric mixture of (CF₃)₂CFCF₂OCH₃ and CF₃CF₂CF₂CF₂OCH₃)) with H₂.

26. The method of claim 17, wherein a cleaning gas mixture comprises azomethane, azo-tertiary butane, benzene azomethane.

27. An in-situ method of cleaning a TCO process chamber used to fabricate solar cells, the method comprising: providing a cleaning gas mixture to the process chamber, wherein the cleaning gas comprises at least one gas selected from the group consisting of Hydrogen Iodide (HI), Methyl Iodide (CH₃I) with H₂, Hydrogen Bromide (HBr), HFE-7100 (isomeric mixture of (CF₃)₂CFCF₂OCH₃ and CF_{3C}F₂CF₂CF₂OCH₃)) with H₂, and wherein the cleaning gas is thermally activated and removes metal-containing contaminants or metal-oxide containing contaminants from interior surfaces of the processing chamber that are exposed to the cleaning gas.

28. An in-situ method of cleaning an Extreme Ultraviolet Lithography (EUV) process chamber, the method comprising: providing a cleaning gas mixture to the process chamber, wherein the cleaning gas comprises at least one gas selected from the group consisting of Hydrogen Iodide (HI), Methyl Iodide (CH₃I) with H₂, Hydrogen Bromide (HBr), HFE-7100 (isomeric mixture of (CF₃)₂CFCF₂OCH₃ and CF₃CF₂CF₂CF₂OCH₃)) with H₂, and wherein the cleaning gas is thermally activated and removes tin-containing contaminants or tin-oxide containing contaminants from an interior surface of the processing chamber that are exposed to the cleaning gas.

29. The method of claim 1, wherein the metal is a Group IIIA, IVA, VA, VIA element.

30. The method of claim 29, wherein the process chamber is that of a thermal ALD or Plasma Enhanced ALD systems and the metal-containing contaminants include Al, AlN, AlO₂, Bi, Bi₂O₃, BiFeO₃, Co, Ni, W, CoFe₂O₄, Ge, GeₓSb_{y}Te_{z}, Hf, HfO₂, HfSiOₓ, La, La₂₋ₓYₓO₃, LaAlO₃, La₂O₃, Sb, Sr₂O₃, Ba₂O₃, Mn, Mn₄N, Mo, MoO₃, Nb, NiO, Ru, RuO₂, SrTiO₃, Ta, TaN, Te, Si, Ti, TiN, TiON, TiO₂, V, VN, W, WN, and (SiN).
